(19) United States
(12) Patent Application Publication
(10) Pub. No.: US 2025/0294169 A1
(43) Pub. Date: Sep. 18, 2025

(54) DATA COMPRESSION SYSTEM

(71) Applicant: Hitachi Vantara, Ltd., Yokohama-shi (JP)

(72) Inventors: Akifumi SUZUKI, Tokyo (JP); Masanori TAKADA, Tokyo (JP); Hiroaki AKUTSU, Tokyo (JP)

(73) Assignee: Hitachi Vantara, Ltd., Yokohama-shi (JP)

(21) Appl. No.: 18/830,321

(22) Filed: Sep. 10, 2024

(30) Foreign Application Priority Data
Mar. 15, 2024 (JP) 2024-041259

(51) Int. Cl. H04N 19/167; H04N 19/162; H04N 19/17; H04N 19/426; H04N 19/46

(52) U.S. Cl. CPC H04N 19/167; H04N 19/162; H04N 19/17; H04N 19/426; H04N 19/46

(57) ABSTRACT

A data compression system includes a storage system for storing moving image data and associated metadata; and a data compression system. The data compression system further includes: an interface to register a compression setting; and a compression function unit that compresses and decompresses the data. The compression setting includes a designated object that indicates an imaging region arbitrarily designated in the data; and a metadata association setting that associates the compression setting with the metadata. The compression function unit includes: a first function of acquiring the data in the storage system as compression target moving image data; and a second function of acquiring metadata given to the compression target moving image data and the compression setting, and the compression function unit compresses the compression target data acquired based on the first function according to the compression setting acquired based on the second function and creates a compressed moving image data.

### BACKGROUND OF THE INVENTION

### 1. Field of the Invention

The present invention relates to data compression processing for the purpose of reducing a data amount of moving image data.

### 2. Description of the Related Art

As a background art of the present invention, JP 2020-155071 A discloses a technique in which in order to optimize a storage cost for data, in a storage system including a storage device, a memory, and a processor configured to control input and output of data to and from the storage device, the processor monitors a storage amount that is at least one of a write amount (a total amount of data received as a write target) and a physical use amount (a total amount of data physically stored in the storage device), and a read amount (a total amount of data that is read), and calculates a fee as a storage cost that is a cost related to use of the storage device in a target period, based on a storage amount and a read amount in the target period in accordance with a monitoring result.

### SUMMARY OF THE INVENTION

However, the technique described in JP 2020-155071 A has room for improvement in efficiently compressing moving image data stored in the storage system.

The present invention has been made in view of the above problems, and an object thereof is to provide a data compression system capable of efficiently compressing moving image data stored in a storage system.

A data compression system according to the present invention is a data compression system including: a storage system that stores moving image data and metadata given to the moving image data; and a moving image data compression system that communicates with the storage system via a network, the data compression system further including: an interface to register a setting related to compression processing; and a compression function unit that is included in the moving image data compression system and compresses and decompresses the moving image data, in which the setting related to the compression processing includes: a compression setting including a designated object that is information indicating an imaging region arbitrarily designated in the moving image data; and a metadata association setting that associates the compression setting with the metadata, the compression function unit includes: a first function of acquiring the moving image data in the storage system as compression target moving image data; and a second function of acquiring metadata given to the compression target moving image data and acquiring the compression setting, associated with the metadata, according to the metadata association setting, and the compression function unit compresses the compression target moving image data acquired based on the first function according to the compression setting acquired based on the second function and creates a compressed moving image data.

In addition, the problem disclosed in the present application and the method for solving the problem will be clarified in the Description of the Preferred Embodiments and with reference to the drawings.

According to the present invention, it is possible to provide a data compression system capable of efficiently compressing moving image data stored in a storage system.

### BRIEF DESCRIPTION OF THE DRAWINGS

FIG. 1 is an overall configuration diagram of a data compression system according to a first embodiment;

FIG. 2 is a schematic diagram of a compression/decompression system according to the first embodiment;

FIG. 3 is a schematic diagram of a compressor according to the first embodiment;

FIG. 4 illustrates compression setting mapping management information according to the first embodiment;

FIG. 5 illustrates auto compression rule management information according to the first embodiment;

FIG. 6 illustrates an initial setting 1 according to the first embodiment: a compression setting input flow;

FIG. 7 illustrates an initial setting 2 according to the first embodiment: an automatic compression condition setting input flow;

FIG. 8 illustrates a data storage flow of a user according to the first embodiment;

FIG. 9 illustrates a compression target moving image data search processing flow according to the first embodiment; and

FIG. 10 illustrates a compression processing flow according to the first embodiment.

### DESCRIPTION OF THE INVENTION

In order to reduce a data amount of a moving image or a still image, it is effective to reduce the data amount by detecting an object in which a user is interested by a neural network or the like, maintaining only an image quality of the object, and reducing the image quality of a region other than the object.

In such a technique, the user needs to specify and compress an object of interest included in a moving image or an image to be compressed. Hereinafter, in the present embodiment, setting of various conditions regarding compression including specifying an object of interest for compression is referred to as “compression setting”.

Since compression using a neural network or the like requires a large amount of calculation processing, a large amount of main storage memory is consumed, and special hardware such as a GPU is used as a processing resource; therefore, it is desirable to perform processing by a server different from an existing server or storage. Thus, a configuration for providing a “compression/decompression service” that make compression or decompression processing available as a service is useful.

Hereinafter, an embodiment of the present invention will be described with reference to the drawings. The present invention is not limited to the embodiments, examples, and modifications described below.

The term “compression” in the present specification means lossy compression processing, and reduces the data amount by changing the image quality (that is, reducing the image quality to a degree desired by the user).

The term “service” in the present specification refers to a service in an on-premises or cloud environment, and indicates a service that externally discloses an application programming interface (API) of software used in the service, receives a request from the outside through the API, and returns a response. This service may be configured by operating a serverless system in a public cloud, or may be configured by operating a group of processes processed by a server in an on-premises environment.

The term “moving image” in the present specification may be a moving image including not only a moving image but also an image such as a still image.

### First Embodiment

### <Overall Configuration of Data Compression System According to First Embodiment>

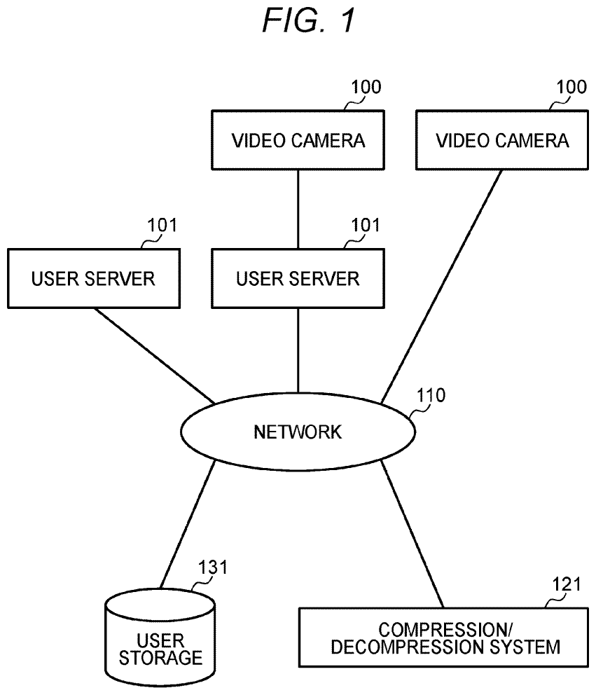

FIG. 1 is a diagram illustrating an overall configuration of a data compression system according to a first embodiment. The data compression system includes a video camera 100, a user server 101, a compression/decompression system 121, and a user storage 131.

The user server 101, the compression/decompression system 121, and the user storage 131 may be a physical server or a physical storage operating in an on-premises environment, or may be an instance (virtual server, virtual storage) on a public cloud system.

The data compression system 1 is a system constructed by the video camera 100, the user server 101 that aggregates data acquired from the video camera 100, the user storage 131 that stores moving image data, the compression/decompression system 121 that acquires the moving image data stored in the user storage 131, compresses the moving image data, and transfers a compression result to the user storage 131, and a network 110 that communicably connects these subsystems and devices.

The user server 101 is a server that uses a volume provided by the user storage 131 as a storage region. In the present embodiment, the user server 101 is a general server having a CPU, a DRAM, and a network interface, and performs a plurality of settings in data compression for the compression/decompression system 121 via the network 110. The moving image data held in the user server 101 is stored in the user storage 131.

The video camera 100 is a device that captures a moving image. The moving image captured by the video camera 100 is stored in the user server 101 depending on an installation mode, and is stored in the user storage 131 by the user server 101. Unlike the above aspect, the moving image captured by the video camera 100 may be stored in the user storage 131 directly via the network 110 without the user server 101.

The network 110 is a network capable of communicating various data, and may be a global Internet or a closed network in a public cloud. Furthermore, the network is not limited to IP communication, and may be a network that connects the user server 101 and the compression/decompression system 121 according to a standard such as PCI-Express.

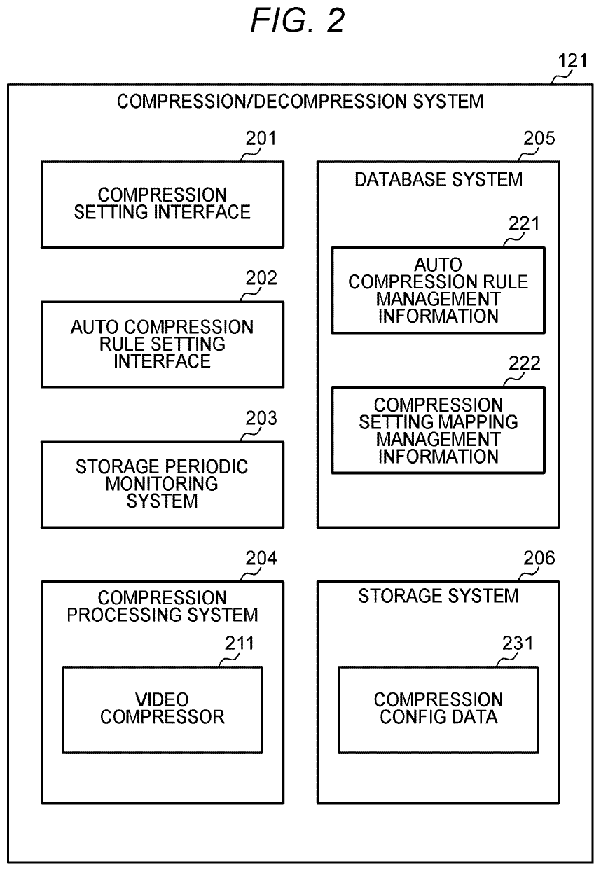

The compression/decompression system 121 is a system to which the present embodiment is applied. The compression/decompression system 121 performs various processing of compression/decompression based on an automatic compression condition setting set from the user server 101. This automatic compression condition setting will be described later with reference to FIG. 7. Furthermore, the compression/decompression system 121 internally includes a processor such as a CPU for processing a neural network, a GPU, or hardware dedicated to neural network processing, and performs compression processing of a moving image using these resources. Details of the compression/decompression system 121 will be described later with reference to FIG. 2. The compression/decompression system 121 may provide both a compression system and a decompression system, or may provide only the compression system.

The user storage 131 is a storage used by the user to store moving image data, and targets an object storage. The present invention is not limited to this example, and the user storage 131 may be a file storage or the like. In order to manage data for each moving image data to be stored, the user storage 131 can assign a plurality of tags as metadata. The tag in the present embodiment may be metadata itself. In the present embodiment, when moving image data is stored in the user storage 131, a tag is automatically assigned based on an IP address of the user server 101 or the video camera 100 as a transfer source by an automatic tag assignment function (“automatic tag assignment system” to be described later).

As a method of assigning a tag to moving image data, for example, when the moving image data is directly transferred from the video camera 100 monitoring a road to the user storage 131, the user storage 131 assigns a tag (for example, information such as “road monitoring”), indicating that the moving image data is a moving image in which the road is monitored, to the moving image data stored in the user storage 131 based on the IP address of the video camera 100 monitoring the road. The tag may be a character string related to the use of the moving image (for example, “moving image for maintenance purpose”), or may be a character string related to an installation location (for example, “moving image of No. n platform at n station”) of the video camera 100.

In the present embodiment, although an example in which a tag is automatically assigned by the IP address of a transfer source device will be described, the present invention is not limited to this example. For example, ID information such as a serial number of the transfer source device (video camera 100), GPS information, and the like are simultaneously acquired as log information together with moving image data, and then stored in the user storage 131, and a tag may be automatically assigned by analyzing the log information. When a character string of a MAC address of the transfer source device (video camera 100) or a name arbitrarily set by the user for management of the transfer source device is included as a file name of a moving image or a path of a directory storing the moving image, a tag may be assigned from the file name or the path. A tag such as “moving image captured in winter” or “moving image captured at night” may be assigned using time information stored in the storage, and any tag may be assigned as long as the user can automatically assign the tag in storing moving image data in the user storage 131.

### <Compression/Decompression System 121 According to First Embodiment>

FIG. 2 is a diagram for explaining the compression/decompression system 121 according to the first embodiment. The compression/decompression system 121 in the present embodiment includes a compression setting interface 201, an auto compression rule setting interface 202, a storage periodic monitoring system 203, a compression processing system 204, a database system 205, and a storage system 206. Any system may be realized by the user arbitrarily combining and operating resources provided as a service from a third party.

The compression setting interface 201 is used by the user server 101 via the network 110, and is an interface through which the user inputs a compression setting which is various settings in the compression processing of the moving image.

The compression setting interface 201 is provided for the user as a web graphical user interface (GUI) accessible from a web browser (for example, Google Chrome (registered trademark) or the like) or as an API (for example, post request) according to an http request.

The provision of the compression setting interface 201 is not limited to the above-described provision mode, and any provision mode may be used as long as the user can specify a plurality of setting items used for the compression processing, such as an “object of interest”, a compression algorithm, an image quality difference between a high image quality region and a low image quality region, a frame rate of compressed moving image data, and a resolution of the compressed moving image data.

The compression setting includes the plurality of setting items used for the compression processing, such as the “object of interest”, the compression algorithm, the image quality difference between the high image quality region and the low image quality region, the frame rate of the compressed moving image data, and the resolution of the compressed moving image data.

The “object of interest” refers to an object maintained at high image quality among various objects captured in a moving image, and is set by designation or input by the user. The video compressor 211 maintains high image quality only for an object designated as the “object of interest” among various objects captured in the moving image, and reduces the data amount by lowering the image quality for a region other than a region where object other than the object in the moving image is photographed. For example, when a “vehicle” is designated as the “object of interest”, only a region where the vehicle is photographed is maintained with high image quality, and the image quality is reduced for a region where an object other than the “object of interest” is photographed in the moving image, that is, a region such as a building or a road where the vehicle is not photographed, thereby reducing the data amount. As a method of designating the “vehicle” as the “object of interest”, for example, a region corresponding to the “object of interest” may be dragged and designated on an arbitrary still image or moving image, or the region may be designated by inputting a character string designating the “object of interest” such as the “vehicle” or an “automobile”. In the present embodiment, as a method of designating the “object of interest”, a method of specifying the “object of interest” by dragging by the user and a method of specifying the object by a character string will be described as examples. However, the present invention is not limited to these examples, and any method may be used as long as the method is a method of designating the object as a target in an object detection function by a deep learning technology.

In place of the setting of the object of interest described above, the compression setting may include designation of a region or an object that lowers the image quality. That is, the object of interest may be understood as a region in the moving image set as a region for designating that the image quality is controlled by the user, and may also be referred to as a designated object.

The compression setting set by the compression setting interface 201 is stored as compression configuration data 231 in the storage system 206. The compression configuration data 231 may be stored in the database system 205, and may be any data as long as various compression settings can be held for a desired period.

In addition to the above-described function of setting the object of interest, the compression setting interface 201 provides a function of managing the stored compression configuration data 231 and the tag assigned to the moving image data managed by the user storage 131 in association with each other. A tag associated with each compression setting can be arbitrarily designated. More specifically, after storing the compression configuration data 231 in the storage system 206, the compression setting interface 201 provides the user with a function of associating a desired tag with the compression configuration data 231. The information on the association between the compression configuration data 231 and the tag is defined as a storage path that is information indicating a storage location of the compression configuration data 231 associated from each tag, and is stored as compression setting mapping management information 222 in the database system 205. The compression setting mapping management information 222 may be stored in the storage system 206. The number of tags associated with one compression setting may be two or more.

The auto compression rule setting interface 202 is used by the user server 101 via the network 110, and is an interface for the user to set a condition for automatic compression. The compression/decompression system 121 of the present embodiment has a function of not only receiving a compression request for individually compressing each moving image data from the user and performing compression processing, but also automatically performing the compression processing on all moving image data satisfying a condition specified by the user with respect to a large amount of moving image data stored in the user storage 131.

The automatic compression condition designated by the auto compression rule setting interface 202 is stored as the auto compression rule management information 221 in the database system 205. Details of the auto compression rule management information 221 will be described later. The auto compression rule management information 221 may be stored in the storage system 206.

The storage periodic monitoring system 203 is a system or a process in a server that searches for the presence or absence of moving image data to be compressed (hereinafter, referred to as “compression target moving image data”)) based on the auto compression rule management information 221 stored in the database system 205 in the compression/decompression system 121.

The storage periodic monitoring system 203 is a system or a process in a server, which is periodically started, acquires the auto compression rule management information 221 every minute, for example, and specifies a monitoring target region of the user storage 131 based on a value of “input data location 501” of the auto compression rule management information 221. Then, it is determined whether the automatic compression condition designated by the user is satisfied for all the moving image data in the monitoring target region. For the moving image satisfying the condition in this determination, a compression request is issued to the compression processing system 204 described later. Details of the “input data location 501” will be described later with reference to FIG. 5.

The storage periodic monitoring system 203 may not acquire the auto compression rule management information 221 every minute, but may acquire the automatic compression condition every arbitrary time.

The compression processing system 204 is a system or a process in a server, which analyzes the compression request requested to the compression processing system 204 and compresses the moving image data based on the request.

The compression processing system 204 performs the compression processing using the internal video compressor 211.

The video compressor 211 maintains high image quality only for an object designated as the “object of interest” by the user among various objects captured in the moving image, and reduces the data amount by lowering the image quality for the region other than the region where object other than the object in the moving image is photographed. When the region in which the image quality is reduced is included as the designated object in the compression setting instead of the object of interest, the image quality of the designated object portion may be reduced with respect to other regions to reduce the data amount.

When performing the compression processing, the compression processing system 204 acquires the moving image data and the tag from the compression target moving image data described in the compression request. Then, based on the acquired tag, the compression setting mapping management information 222 in the database is referred to, and the storage location of the compression configuration data 231 in the storage system 206 is acquired. Then, the corresponding compression configuration data 231 is acquired from the storage system 206, the moving image data and the compression configuration data 231 are given to the video compressor 211, and suitable compression processing is performed. Then, the compressed moving image data for which the compression processing has been completed is stored in the storage location of the user storage 131 described in the compression request.

The database system 205 is a system of a database or a process in a server that stores the auto compression rule management information 221 and the compression setting mapping management information 222 used by the compression/decompression system 121.

The storage system 206 is a system of a storage or a process in a server, which stores the compression configuration data 231 for performing the compression processing with the compression setting specified by the user when the compression processing system 204 compresses the moving image data.

### <Video Compressor 211 According to First Embodiment>

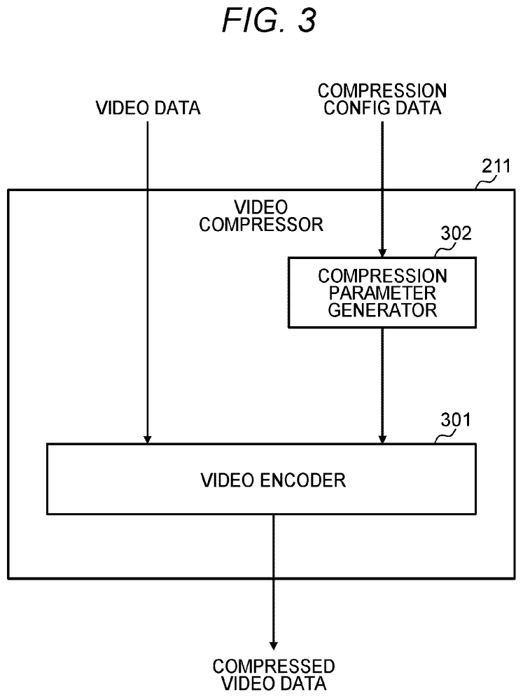

FIG. 3 is a diagram for explaining an outline of the video compressor 211 according to the first embodiment. The video compressor 211 is under the control of the compression processing system 204, and operates when the moving image data and the compression configuration data 231 are input from the compression processing system 204. The video compressor 211 includes a video encoder 301 and a compression parameter generator 302.

The video encoder 301 encodes the input moving image data with a specified compression parameter to reduce the data amount. The video encoder 301 includes a function of once decoding moving image data when the moving image data is in a format that cannot be encoded and converting the moving image data into a state that can be encoded. The video encoder 301 receives the moving image data and the compression parameter from the compression parameter generator 302 as inputs.

The compression parameter generator 302 is a process of generating a parameter used when the video encoder 301 compresses a moving image based on the compression configuration data 231 and the moving image data. The compression parameter generator 302 performs processing of the neural network, detects the “object of interest” for each scene of the input moving image data by using information for detecting the “object of interest” included in the compression configuration data 231, and generates annotation data that is information representing a region to be left with high image quality and a region to be lowered in image quality. The generation of the annotation data can be executed using the neural network or another machine learning model even when a region where the image quality is reduced is designated as the designated object instead of the object of interest.

Then, a compression parameter obtained by combining the generated annotation data and another compression setting (frame rate of compressed moving image data, resolution of compressed moving image data, etc.) included in the compression configuration data 231 is input to the video encoder 301.

For example, when the moving image data including a plurality of pictures is compressed per second, a plurality of pieces of still image data generated by dividing the moving image data are input to the compression parameter generator 302. Then, the compression parameter generator 302 detects the “object of interest” for each of the plurality of pieces of still image data, and creates the plurality of pieces of annotation data. Then, the plurality of pieces of still image data, the plurality of pieces of annotation data, and another compression setting (frame rate of compressed moving image data, resolution of compressed moving image data, etc.) included in the compression configuration data 231 are input to the video encoder 301. Then, the video encoder 301 compresses each of the still image data and the annotation data according to another compression setting, thereby creating compressed moving image data for 1 second.

In this case, an example of generating the compression parameter using the neural network will be described; however, the present invention is not limited to this example, and the compression parameter may be generated by an arbitrary method from the moving image data and the compression configuration data 231 that is the auxiliary information. For example, fetching and compression may be performed using, as parameters, conditions such as always leaving an upper half region of the moving image data with high image quality and lowering a compression rate for lowering the image quality of the lower half region. The compression configuration data 231 may be directly input to the video encoder 301 without using the compression parameter generator 302.

### <Compression Setting Mapping Management Information 222 According to First Embodiment>

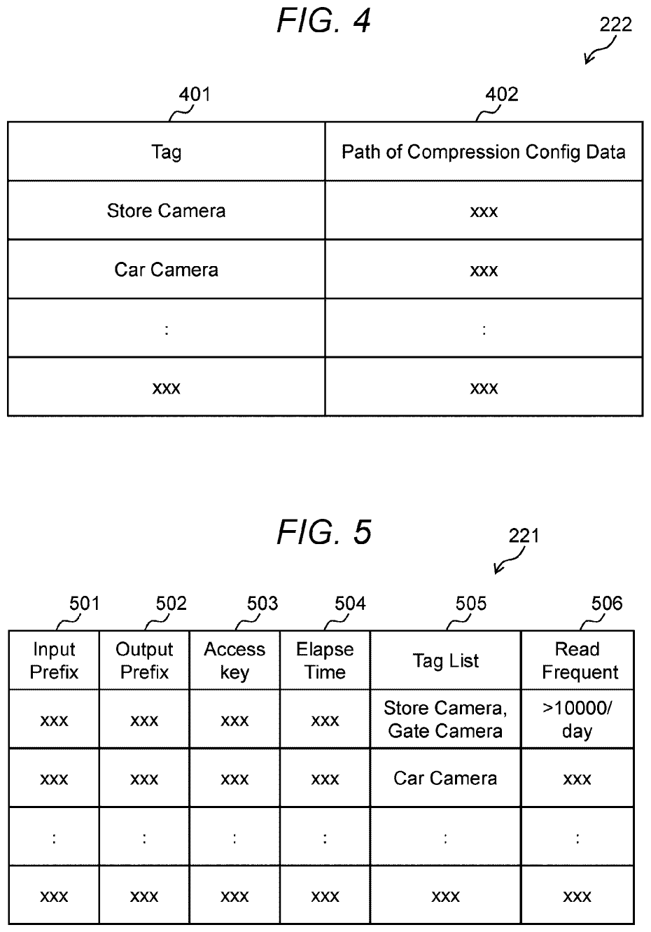

FIG. 4 is a diagram for explaining the compression setting mapping management information 222 according to the first embodiment. The compression setting mapping management information 222 includes a tag 401 and a compression configuration data path 402.

The tag 401 is information serving as a key when the compression setting mapping management information 222 is referred to, and is a field in which a tag (character string in the present embodiment) assigned to the moving image data managed by the user storage 131 is stored. For example, when a tag called “in-vehicle camera” is used, the tag called “in-vehicle camera” is stored in this field.

The compression configuration data path 402 is a field in which a path representing a storage location of the compression configuration data 231 in the storage system 206 is stored.

As the association between the tag 401 and the compression configuration data path 402 in the compression setting mapping management information 222, for example, when the user specifies a compression setting for leaving a vehicle with high image quality as the compression setting of the moving image captured by the in-vehicle camera, the “in-vehicle camera” is stored in the tag 401, and the storage location of the compression configuration data 231 in which the compression setting for leaving the vehicle with high image quality is recorded in the compression configuration data path 402 is stored in association with each other. As a result, when the compression processing system 204 to be described later refers to the compression setting mapping management information 222 using the tag called “in-vehicle camera” as a key, it is possible to acquire the storage location of the compression configuration data 231 of the compression setting that leaves the vehicle with high image quality.

### <Auto Compression Rule Management Information 221 According to First Embodiment>

FIG. 5 is a diagram for explaining the auto compression rule management information 221 according to the first embodiment. The auto compression rule management information 221 includes the input data location 501, an output data location 502, an access key 503, an elapsed time 504 from storage, a target Tag list 505, and a read frequency 506.

The auto compression rule management information 221 is referred to by the storage periodic monitoring system 203, and is used when the moving image data corresponding to the automatic compression condition is searched among a plurality of pieces of moving image data in the user storage 131.

Each item of auto the compression rule management information 221 is set for each row as a project of the user. The project may be, for example, an ID or the like given for each license registered by the user, or may be set for each folder of the user. The number of projects, IDs, and folders that a user has may be one or more per user.

The input data location 501 is a field in which a condition regarding a range in which the storage periodic monitoring system 203 searches for the moving image data corresponding to the automatic compression condition is stored. A value indicating a specific directory in the user storage 131 is stored in the input data location 501. The storage periodic monitoring system 203 searches whether all the moving image data under the directory correspond to the automatic compression condition.

The output data location 502 is a field in which a condition regarding the storage location of the compressed moving image data in which the data amount is reduced by compression for the moving image data corresponding to the automatic compression condition is stored. A value indicating a specific directory in the user storage 131 is stored in the output data location 502. The storage periodic monitoring system 203 notifies the compression processing system 204 of a compression request including a path in the user storage 131 for storage to store the compressed moving image data in the directory.

The output data location 502 is not essential. For example, when there is no column of the output data location 502 or when there is no value stored in the output data location 502, the compression target moving image data may be replaced with the compressed moving image data and overwritten.

The access key 503 is a field for storing authentication information necessary for accessing the user storage 131. The access key 503 is used for authentication when the storage periodic monitoring system 203 and the compression processing system 204 access the user storage 131.

The access key 503 is not essential. For example, when the user storage 131 does not perform any access restriction and various systems constituting the compression/decompression system 121 can access the user storage 131, there may be no column of the access key 503, or there may be no value stored in the access key 503.

The elapsed time 504 from storage is a field for storing a condition regarding an elapsed time from a time when the moving image data to be automatically compressed is stored in the user storage 131. For example, when a value of “one week” is stored at the elapsed time 504 from storage, for one week from the storage of the moving image data in the user storage 131, the moving image data is not a target of the automatic compression, and after one week has elapsed, the moving image data is the target of the automatic compression and corresponds to the automatic compression condition. By setting the elapsed time 504 from storage as one of the automatic compression conditions, the compression technology of the present invention is not applied to the moving image data in which the number of elapsed days from the storage is small and which has applicability to various uses (possibility of becoming an analysis target of various analysis software), and the compression of the present technology can be automatically applied only to the moving image data in which the number of elapsed days from the storage is large and which is no longer used for limited purposes.

The elapsed time 504 from storage is not essential. For example, in a case where there is no column of the elapsed time 504 from storage or in a case where there is no storage of the value of the elapsed time 504 from storage, the case immediately corresponds to the automatic compression condition as soon as the storage periodic monitoring system 203 finds the moving image data.

The tag list 505 is a field for storing a condition regarding the tag (plural types) of the moving image data to be automatically compressed. When there is no value stored in the tag list 505, even moving image data that satisfies the elapsed time 504 from storage (condition regarding an elapsed time from time stored in the user storage 131), which is one of the automatic compression conditions, is not the target of the automatic compression.

A column of the tag list 505 is not essential. For example, when there is no column of the tag list 505, the moving image data satisfying another automatic compression condition is the target of the automatic compression regardless of the tag added to the moving image data, and corresponds to the automatic compression condition.

The read frequency 506 is a field for storing a condition of a read frequency of the moving image data to be automatically compressed. When a value is stored in the read frequency 506 (hereinafter, this value is referred to as a “set value”), the moving image data having a read frequency equal to or more than the set value is the target of the automatic compression and corresponds to the automatic compression condition.

By setting the read frequency 506 as one of the automatic compression conditions, in a system charged for a read data amount, it is possible to obtain an effect of preferentially compressing only the moving image data called frequently and reducing the charge for the read data amount, or improving performance of the storage by compressing the moving image data having a high read frequency.

In the present embodiment, three conditions of the elapsed time 504 from storage, the tag list 505, and the read frequency 506 are described as the automatic compression conditions; however, the present invention is not limited to this example. For example, there may be a condition such as a data amount, and the moving image data having a small data amount may be set so as not to be the target of the automatic compression.

### <Initial Setting 1 According to First Embodiment: Compression Setting Input Flow>

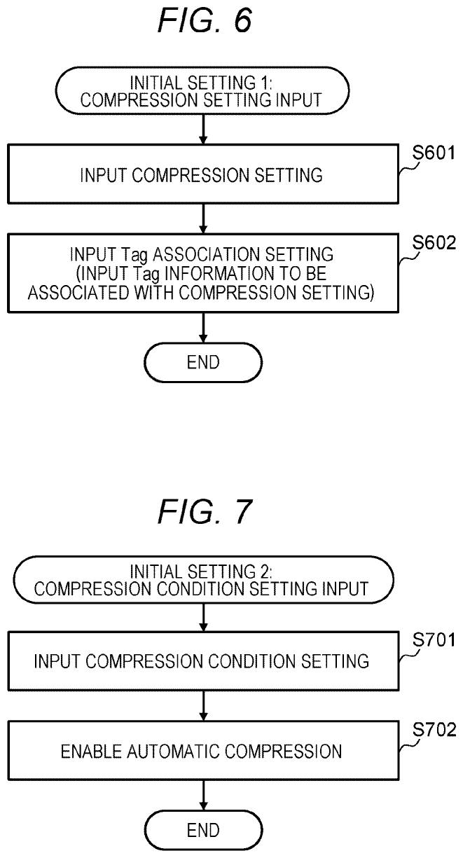

FIG. 6 is a flowchart of a compression setting input according to the first embodiment. The compression setting input flow is one of initial settings performed by the user. The compression setting input flow is a flow in which a user associates a compression setting for a specific tag, and can be performed by using the compression setting interface 201 via the network 110 at an arbitrary timing.

In step S601, the user inputs the compression setting via the compression setting interface 201. That is, the user inputs, as the compression setting, a plurality of setting items used for the compression processing, the setting items including the designation of the “object of interest”, the compression algorithm, the image quality difference between the high image quality region and the low image quality region, the frame rate of the compressed moving image data, and the resolution of the compressed moving image data. Then, the compression setting interface 201 generates the compression configuration data 231 including information for detecting the “object of interest”, the plurality of setting items, and the like. Then, the compression setting interface stores 201 the generated compression configuration data 231 in the storage system 206. The information for detecting the “object of interest” includes, for example, a feature amount representing the object for generating, by the compression parameter generator 302, a region where the object is photographed.

In step S602, the user inputs a tag desired to be associated with the compression configuration data 231 stored in the storage system 206 in step S601. That is, the user inputs, as a tag association setting, each tag desired to be associated with each of the compression configuration data 231 among the tags added to the moving image data managed by the user storage 131. Then, the compression setting interface 201 associates the storage path of the compression configuration data 231 stored in the storage system 206 in step S601 with the input tag, and stores the data as the compression setting mapping management information 222 in the database system 205. The compression setting input flow may be performed at least once for each of different tags even when there are a large amount of various types of moving image data. That is, it is possible to apply a suitable compression setting only by initial setting to a large amount of various types of moving image data, and it is possible to reduce an amount of work for the user.

### <Initial Setting 2 According to First Embodiment: Automatic Compression Condition Setting Input Flow>

FIG. 7 is a flowchart of an automatic compression condition setting input according to the first embodiment. The automatic compression condition setting input flow can be performed by using the auto compression rule setting interface 202 via the network 110 at an arbitrary timing when the user sets automatic compression.

In step S701, the user inputs the automatic compression condition setting via the auto compression rule setting interface 202. That is, the user sets a directory in the user storage 131 in which the moving image data is stored, and inputs authentication information for accessing the directory. A recording destination directory of the compressed data is designated. A condition (conditions regarding the elapsed time 504 after storage, the tag list 505, the read frequency 506, and the like) of a moving image to be automatically compressed is input. Then, after receiving the input of the automatic compression condition setting from the user, the auto compression rule setting interface 202 records and updates the input information in the auto compression rule management information 221 stored in the database in the compression/decompression system 121.

In step S702, the user enables the automatic compression setting set in step S701. That is, the user inputs to enable the automatic compression condition setting. Then, the auto compression rule setting interface 202 to which the input of the validation has been made instructs to search for the compression target moving image data using the automatic compression condition input to the storage periodic monitoring system 203.

The automatic compression condition setting input flow may be performed at least once for each of different conditions even when there are a large amount of various types of moving image data. That is, it is possible to automatically send the compression request at a suitable timing only by initial setting to a large amount of various types of moving image data, and it is possible to reduce the amount of work for the user.

### <Moving Image Data Storage Flow According to First Embodiment>

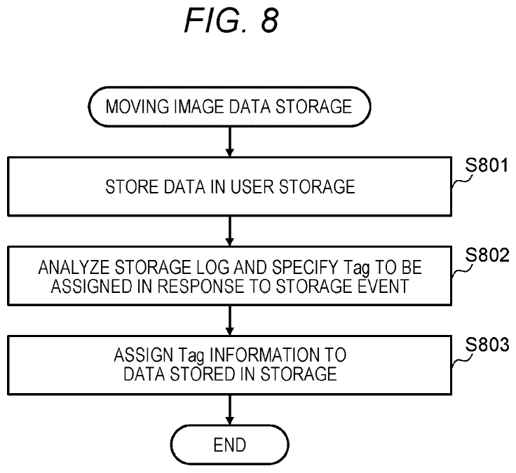

FIG. 8 is a flowchart of moving image data storage according to the first embodiment.

In step S801, the user server 101 or the video camera 100 transfers and stores the recorded moving image data in the user storage 131.

In step S802, the user storage 131 issues an event to the automatic tag assignment system, and automatically assigns a tag or metadata to the moving image data stored in the user storage 131.

The automatic tag assignment system is a process of a public cloud serverless system or a process of a server which is activated when the moving image data is stored in the user storage 131. The automatic tag assignment system includes a tag to be assigned for each IP address of the user server 101 or the video camera 100 as a transfer source. That is, the automatic tag assignment system analyzes a storage log generated by the user server 101 or the video camera 100, specifies the IP address of the transfer source of the moving image data stored in the user storage 131, and determines the tag to be assigned.

Although an example of determining a Tag to be assigned based on a transfer source IP of the moving image data will be described, the present invention is not limited to this example, and an ID of a camera device of the transfer source may be used. The user may manually determine a tag to be assigned to the moving image data.

In step S803, the tag specified in step S802 is assigned to the moving image data.

### <Compression Target Moving Image Data Search Processing Flow According to First Embodiment>

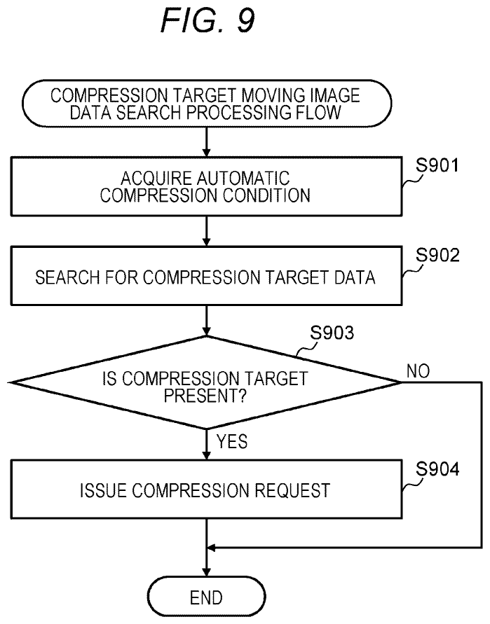

FIG. 9 is a flowchart of compression target moving image data search processing according to the first embodiment. The compression target moving image data search processing flow is a flow executed by the storage periodic monitoring system 203 in the compression/decompression system 121, and is repeatedly executed periodically. For example, the compression target moving image data search processing flow is repeatedly executed every predetermined period (once per minute, once per second, etc.) in the compression/decompression system 121. The compression/decompression system 121 that performs this flow may perform the search processing one by one for each project using a single processor, or may perform a plurality of the search processing in parallel using a plurality of processors.

In step S901, the storage periodic monitoring system 203 accesses the database system 205 and acquires the auto compression rule management information 221.

In step S902, the storage periodic monitoring system 203 searches for the compression target moving image data. That is, the storage periodic monitoring system 203 checks the value of the input data location 501 included in the auto compression rule management information 221 acquired in step S901. Then, the storage periodic monitoring system 203 acquires all the moving image data lists under the directory of the user storage 131 designated by the value of the input data location 501.

When the user storage 131 needs to be authenticated in the acquisition of the moving image data, the storage periodic monitoring system 203 checks the value of the access key 503 included in the auto compression rule management information 221 acquired in step S901. Then, the storage periodic monitoring system 203 performs authentication using the value of the access key 503 to acquire the moving image data list.

Then, the storage periodic monitoring system 203 acquires the time stored in the user storage 131 for each moving image data described in the moving image data list. Further, the storage periodic monitoring system 203 calculates a difference between the current time and the stored time, and calculates an elapsed time from the time when the moving image data is stored in the storage periodic monitoring system 203. Furthermore, when the elapsed time is larger than the value of the “elapsed time 504 from storage” included in the auto compression rule management information 221, the storage periodic monitoring system 203 sets the moving image data as a compression target moving image data candidate satisfying a condition 1.

The storage periodic monitoring system 203 checks whether there is moving image data to which Tag having a value described in the tag list 505 included in the auto compression rule management information 221 is assigned for each moving image data described in the moving image data list. Then, the storage periodic monitoring system 203 sets the moving image data to which the tag having the value described in the tag list 505 is assigned as the compression target moving image data candidate satisfying a condition 2.

The storage periodic monitoring system 203 calculates the read frequency for each moving image data described in the moving image data list. Then, when the read frequency is larger than the value of the “read frequency 506” included in the auto compression rule management information 221, the storage periodic monitoring system 203 sets the moving image data as a compression target moving image data candidate satisfying a condition 3.

The storage periodic monitoring system 203 sets the compression target moving image data candidate satisfying all of the condition 1, the condition 2, and the condition 3 as the compression target moving image data. The storage periodic monitoring system 203 may set the compression target moving image data candidate satisfying at least one of the condition 1, the condition 2, and the condition 3 as the compression target moving image data. In the present embodiment, three conditions are described as the conditions of the automatic compression; however, the present invention is not limited to this example, and there may be two or less conditions or four or more conditions.

Step S903 is a step of branching depending on the presence or absence of the compression target moving image data searched in step S902. In step S902, when there is no compression target moving image data (step S902: No), the compression target moving image data search processing flow ends. On the other hand, in step S902, when there is the compression target moving image data (step S902: Yes), the processing proceeds to step S904.

In step S904, the storage periodic monitoring system 203 issues a compression request to the compression processing system 204. Then, the issued compression request is accumulated in a queue management system in the compression processing system 204. A plurality of the queue management systems may be provided. The compression request includes a path (path based on the value of the input data location 501) of the compression target moving image data in the user storage 131, a path (path based on the value of the output data location 502) in the user storage 131 that stores the compressed moving image data, and the like. Authentication information (information based on the access key 503) necessary for accessing the user storage 131 may be included.

### <Compression Processing Flow According to First Embodiment>

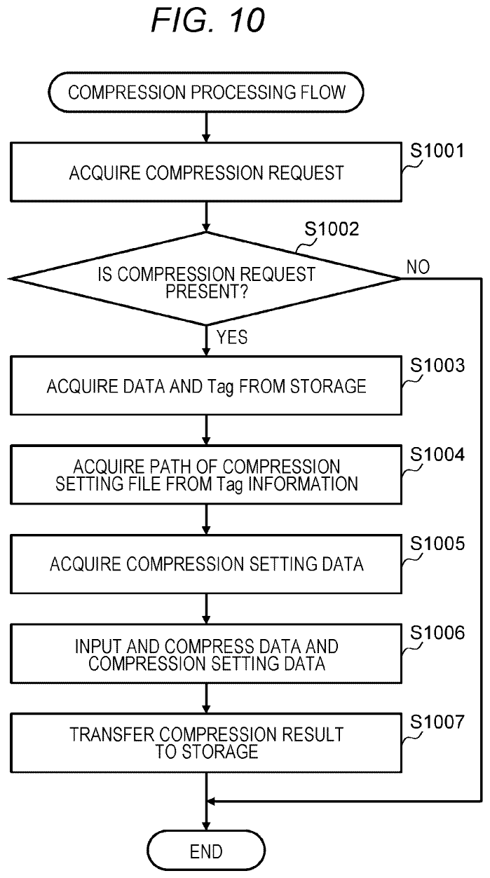

FIG. 10 is a flowchart of a compression processing according to the first embodiment. The compression processing flow is a flow executed by the compression processing system 204, and is repeatedly executed periodically. For example, the compression processing flow is repeatedly executed every predetermined period in the compression/decompression system 121.

In step S1001, the compression processing system 204 acquires a compression request. That is, the compression processing system 204 includes the queue management system therein, and acquires a compression request from the queue management system.

Step S1002 is a step of branching depending on the presence or absence of the compression request acquired from the queue management system in step S1001. In step S1001, when there is no compression request accumulated in the queue management system and the compression request is not acquired (step S1002: No), the compression processing flow ends. On the other hand, in step S1001, when the compression request is acquired (step S1002: Yes), the processing proceeds to step S1003.

In step S1003, the compression processing system 204 acquires the compression target moving image data and the tag assigned to the compression target moving image data from the user storage 131 based on the information of the compression request. When authentication is necessary for access to the user storage 131, the compression processing system 204 performs authentication using the authentication information (information based on the access key 503) included in the compression request.

In step S1004, the compression processing system 204 acquires the compression setting using the tag acquired in step S1003. That is, the compression processing system 204 refers to the compression setting mapping management information 222, and acquires the path of the compression configuration data 231 associated with the tag using the tag acquired in step S1003 as a key.

In step S1005, the compression processing system 204 acquires the compression configuration data 231 from the storage system 206 using the path of the compression configuration data 231 acquired in step S1004.

In step S1006, the video compressor 211 performs the compression processing using the compression target moving image data acquired in step S1003 and the compression configuration data 231 acquired in step S1005. That is, the compression parameter generator 302 of the video compressor 211 uses the compression target moving image data and the compression configuration data 231 to generate a parameter so as to leave the “object of interest” region of the compression target moving image data with high image quality and reduce the image quality of other regions, and inputs the parameter to the video encoder 301. Then, the video encoder 301 compresses the compression target moving image data using the compression target moving image data and the compression parameter, and creates compressed moving image data with a reduced data amount.

In step S1007, the compression processing system 204 stores the compressed moving image data, created in step S1006, in the user storage 131. That is, the compression processing system 204 stores the compressed moving image data, created in step S1006, in the user storage 131 based on the path (path based on the value of the output data location 502) in the user storage 131 that stores the compressed moving image data described in the compression request.

### Effects of First Embodiment

A user uses a device capable of storing a huge amount of data such as a storage, manages a large amount of various types of moving image data, and compresses the data to reduce storage cost and capacity. At this time, designating compression settings for a large amount of various types of moving image data and requesting compression from the compression system have a problem that a large amount of work is required for the user.

Thus, as described above, in the present embodiment, if the user performs two initial settings of the compression setting input flow and the automatic compression condition setting input flow through the interface provided by the compression/decompression system 121 with respect to a large amount of various types of moving image data, thereafter, only by uploading the large amount of various types of moving image data from the user server 101 or the video camera 100 to the user storage 131, the suitable compression setting is applied, and the moving image data is automatically compressed. Therefore, it is not necessary for the user to issue a request to the compression/decompression system 121 for each of the large amount of various types of moving image data, and a work load of the user can be reduced. By reducing the amount of data, it is possible to reduce a storage capacity to be used, reduce the number of storage drives to contribute to resource saving, and further reduce the power consumption of the storage drive.

### Modification 1 of First Embodiment

For example, regarding the compression processing flow described with reference to FIG. 10, a case where the compression/decompression system 121 performs the compression processing flow on a single server has been described.

However, the present invention is not limited thereto, and for example, in a case where the number of compression requests acquired from the queue management system in step S1001 exceeds an arbitrary value, the number of servers that perform the compression processing may be increased, and the compression processing flow may be performed on the plurality of servers. That is, the compression/decompression system 121 may vary the number of servers that perform the compression processing according to the number of compression requests. This method has an advantage that load distribution related to calculation processing of the compression processing can be performed on a plurality of servers, and compression processing time becomes constant.

### Modification 2 of First Embodiment

For example, in the compression processing flow described with reference to FIG. 10, a case where the compression processing system 204 performs the compression processing on all compression requests in a first-in first-out manner has been described.

However, the present invention is not limited thereto, and the compression processing system 204 may give a compression priority to the compression request and perform the compression processing according to the priority.

As a method of assigning the compression priority, for example, the compression processing system 204 may assign the compression priority for each project. A configuration related to the compression priority is added to the auto compression rule management information 221, and a field for storing the compression priority of the moving image data to be automatically compressed is stored. Then, when the storage periodic monitoring system 203 issues the compression request to the compression processing system 204, the compression request is issued including information regarding the compression priority in addition to the path (path based on the value of the input data location 501) in the user storage 131 of the compression target moving image data and the path (path based on the value of the output data location 502) in the user storage 131 that stores the compressed moving image data.

Here, an example in which the compression priority is assigned for each project has been described; however, the present invention is not limited to this example, and when the compression processing flow is interrupted or scheduled to be interrupted due to the malfunction, maintenance, and the like of the system, the compression processing may be interrupted, and the compression priority may be assigned to the interrupted compression request. For example, in the compression request acquired by the compression processing system 204 in step S1001, when the processing is interrupted in any of steps S1003 to S1007, the compression processing system 204 may give the compression priority to the compression request where this processing is interrupted. This method can also be applied to a case where there is resource control on the provider side according to the present data compression system. For example, as the resource control on the provider side, when the compression processing of the present embodiment is interrupted, the compression processing system 204 may give the compression priority to the compression request where this processing is interrupted.

The compression request to which a high compression priority has been given accumulates the compression request in the queue management system having a high priority (hereinafter, referred to as the “priority queue”) among the plurality of queue management systems. Then, in step S1001, the compression processing system 204 performs the compression processing from the compression request accumulated in the priority queue among the plurality of queue management systems. This method has an advantage that the compression processing can be performed according to the priority.

The embodiments of the present invention described above are summarized as follows.

(1) A data compression system according to the present invention is a data compression system including: a storage system 206 that stores moving image data and metadata given to the moving image data; and a moving image data compression system that communicates with the storage system 206 via a network 110, the data compression system further including: an interface (compression setting interface 201) to register a setting related to compression processing; and a compression function unit that is included in the moving image data compression system and compresses and decompresses the moving image data, in which the setting related to the compression processing includes: a compression setting including object that is information indicating an imaging region arbitrarily designated in the moving image data; and a metadata association setting that associates the compression setting with the metadata, the compression function unit includes: a first function of acquiring the moving image data in the storage system 206 as compression target moving image data; and a second function of acquiring metadata given to the compression target moving image data and acquiring the compression setting, associated with the metadata, according to the metadata association setting, and the compression function unit compresses the compression target moving image data acquired based on the first function according to the compression setting acquired based on the second function and creates a compressed moving image data. With this configuration, the data compression system can efficiently compress the moving image data stored in the storage system 206. That is, according to the present invention, it is possible to provide a data compression system capable of efficiently compressing the moving image data stored in the storage system 206.

(2) The setting related to the compression processing includes automatic compression condition setting for setting an automatic compression condition which is a condition for automatically starting compression, and the first function is a function of acquiring, as the compression target moving image data, the moving image data satisfying the automatic compression condition among the moving image data in the storage system 206 according to the automatic compression condition setting.

(3) The compression function unit has a third function of acquiring one or more pieces of still image data from the compression target moving image data, and the compression function unit compresses the plurality of pieces of still image data, acquired based on the third function, according to the compression setting associated with the metadata acquired based on the second function, and creates the compressed moving image data.

(4) The data compression system has a function of specifying a transfer source of moving image data and automatically setting metadata to be added to the moving image data when the moving image data is stored in the storage system 206.

(5) The compression function unit includes a processor that executes the first function and the second function, and changes the number of processors according to an amount of the compression target moving image data.

(6) The compression target moving image data includes compression priority information indicating priority of the compression processing, and the compression function unit executes the second function on the compression target moving image data having a higher compression priority before the compression target moving image data having a lower compression priority according to the compression priority information of the compression target moving image data acquired according to the first function.

(7) Interest object information includes compression information for setting a first object region to which a first compression rate is applied and a second object region to which a second compression rate lower in compression efficiency than the first compression rate is applied, and the compression function unit executes, for the compression target moving image data, specification of the first object region and application of the first compression rate, and specification of the second object region and application of the second compression rate, according to the compression setting associated with the metadata acquired based on the second function to create the compressed moving image data.

(8) The automatic compression condition includes a plurality of conditions, and the compression function unit determines that the automatic compression condition is satisfied when all of the plurality of conditions are satisfied.

(9) The automatic compression condition includes a condition regarding an elapsed time which is a time elapsed after the moving image data is stored in the storage system 206.

(10) The automatic compression condition includes a condition regarding a read frequency which is a frequency at which the moving image data is read.

The present invention is not limited to the above-described embodiments, examples, and modifications, and can be implemented using arbitrary components without departing from the gist thereof.

Each of the above-described embodiments, examples, and modifications is merely an example, and the present invention is not limited to these contents as long as the features of the invention are not impaired. Although various embodiments, examples, and modifications have been described above, the present invention is not limited to these contents, and all of these contents are not necessarily essential to the solution of the present invention. Other aspects conceivable within the scope of the technical idea of the present invention are also included within the scope of the present invention.

In each of the above drawings, control lines and information lines considered to be necessary for description are illustrated, and not all the control lines and information lines necessary for implementation are illustrated. For example, it may be considered that almost all the components are connected to one another in actuality.

The arrangement form of each function unit of the data compression system described above is merely an example. The arrangement form of each function unit can be changed to an optimum arrangement form from the viewpoint of performance, processing efficiency, communication efficiency, and the like of hardware and software included in the data compression system.

The above-described configurations, functions, processing modules, and processing means, for all or a part of them, may be implemented by hardware: for example, by designing an integrated circuit, and may be implemented by software, which means that a processor interprets and executes programs providing the functions.

1. A data compression system comprising:
a storage system that stores moving image data and metadata given to the moving image data; and
a moving image data compression system that communicates with the storage system via a network,
the data compression system further comprising:
an interface to register a setting related to compression processing; and
a compression function unit that is included in the moving image data compression system and compresses and decompresses the moving image data,
wherein the setting related to the compression processing includes:
a compression setting including a designated object that is information indicating an imaging region arbitrarily designated in the moving image data; and
a metadata association setting that associates the compression setting with the metadata,
the compression function unit includes:
a first function of acquiring the moving image data in the storage system as compression target moving image data; and
a second function of acquiring metadata given to the compression target moving image data and acquiring the compression setting, associated with the metadata, according to the metadata association setting, and
the compression function unit
compresses the compression target moving image data acquired based on the first function according to the compression setting acquired based on the second function and creates a compressed moving image data.

2. The data compression system according to claim 1, wherein
the setting related to the compression processing includes
automatic compression condition setting for setting an automatic compression condition which is a condition for automatically starting compression, and
the first function is
a function of acquiring, as the compression target moving image data, the moving image data satisfying the automatic compression condition among the moving image data in the storage system according to the automatic compression condition setting.

3. The data compression system according to claim 1, wherein
the compression function unit has
a third function of acquiring one or more pieces of still image data from the compression target moving image data, and
the compression function unit
compresses the plurality of pieces of still image data acquired based on the third function, according to the compression setting associated with the metadata acquired based on the second function, and creates a compressed moving image data.

4. The data compression system according to claim 1, wherein the data compression system has a function of specifying a transfer source of moving image data and automatically setting metadata to be added to the moving image data when the moving image data is stored in the storage system.

5. The data compression system according to claim 1, wherein
the compression function unit
includes a processor that executes the first function and the second function, and
changes the number of processors according to an amount of the compression target moving image data.

6. The data compression system according to claim 1, wherein
the compression target includes moving image data compression priority information indicating priority of the compression processing, and
the compression function unit
executes the second function on the compression target moving image data having a higher compression priority before the compression target moving image data having a lower compression priority according to the compression priority information of the compression target moving image data acquired according to the first function.

7. The data compression system according to claim 1, wherein
the designated object information includes
compression information for setting a first object region to which a first compression rate is applied and a second object region to which a second compression rate lower in compression efficiency than the first compression rate is applied, and
the compression function unit executes
for the compression target moving image data, specification of the first object region and application of the first compression rate, and specification of the second object region and application of the second compression rate, according to the compression setting associated with the metadata acquired based on the second function to create a compressed moving image data.

8. The data compression system according to claim 2, wherein
the automatic compression condition includes a plurality of conditions, and
the compression function unit determines that the automatic compression condition is satisfied when all of the plurality of conditions are satisfied.

9. The data compression system according to claim 2, wherein the automatic compression condition includes a condition regarding an elapsed time which is a time elapsed after the moving image data is stored in the storage system.

10. The data compression system according to claim 2, wherein the automatic compression condition includes a condition regarding a read frequency which is a frequency at which the moving image data is read.

11. A compression processing method in a data compression system including a storage system that stores moving image data and metadata given to the moving image data, and a moving image data compression system that communicates with the storage system via a network, the compression processing method comprising a method in which
the data compression system further includes
an interface to register a setting related to compression processing, and
a compression function unit that is included in the moving image data compression system and compresses and decompresses the moving image data,
in which the setting related to the compression processing includes:
a compression setting including a designated object that is information indicating an imaging region arbitrarily designated in the moving image data; and
a metadata association setting that associates the compression setting with the metadata,
the compression function unit includes:
a first function of acquiring the moving image data in the storage system as compression target moving image data; and
a second function of acquiring metadata given to the compression target moving image data and acquiring the compression setting, associated with the metadata, according to the metadata association setting, and
the compression function unit
compresses the compression target moving image data acquired based on the first function according to the compression setting acquired based on the second function and creates a compressed moving image data.
